(19) United States
(12) Patent Application Publication
(10) Pub. No.: US 2012/0126654 A1
(43) Pub. Date: May 24, 2012

(54) PERMANENT MAGNET BRUSHLESS MOTOR

(75) Inventors: Mohammad S. Islam, Saginaw, MI (US); Mohammed Rakibul Islam, Saginaw, MI (US)

(73) Assignee: NEXTEER (BEIJING) TECHNOLOGY CO., LTD., Saginaw, MI (US)

(21) Appl. No.: 13/251,739

(22) Filed: Oct. 3, 2011

Related U.S. Application Data
(60) Provisional application No. 61/416,571, filed on Nov. 23, 2010.

(51) Int. Cl. H02K 1/27; H02K 21/16

(52) U.S. Cl. 310/156.38; 310/216.092

(57) ABSTRACT

A permanent magnet brushless motor is provided. The motor includes a stator having a tubular-shaped member and a plurality of tooth members extending radially inwardly from the tubular-shaped member. Each tooth member has an arcuate-shaped convex surface disposed proximate to an interior region defined by the stator. Each arcuate-shaped convex surface is defined by a first radius that is rotated about a respective center point that is disposed radially outside of the stator. The motor further includes a rotor disposed within the interior region of the stator.

### CROSS-REFERENCES TO RELATED APPLICATIONS

This patent application claims priority to U.S. Provisional Patent Application Ser. No. 61/416,571 filed Nov. 23, 2010, which is incorporated herein by reference in its entirety.

### FIELD OF THE INVENTION

The subject invention relates to a permanent magnet brushless motor.

### BACKGROUND OF THE INVENTION

Brushless motors have been developed. However, the brushless motors can have undesirable amounts of cogging torque.

Accordingly, it is desirable to provide a permanent magnet brushless motor that reduces and/or minimizes cogging torque.

### SUMMARY OF THE INVENTION

In one exemplary embodiment of the present invention, a permanent magnet brushless motor is provided. The motor includes a stator having a tubular-shaped member and a plurality of tooth members extending radially inwardly from the tubular-shaped member. Each tooth member of the plurality of tooth members has an arcuate-shaped convex surface disposed proximate to an interior region defined by the stator. Each arcuate-shaped convex surface is defined by a first radius that is rotated about a respective center point that is disposed radially outside of the stator. The motor further includes a rotor disposed within the interior region of the stator.

The above features and advantages and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a schematic of a permanent magnet brushless motor in accordance with an exemplary embodiment;

FIG. 2 is a cross-sectional view of the permanent magnet brushless motor of FIG. 1;

FIG. 3 is a cross-sectional view of the permanent magnet brushless motor of FIG. 2 taken along lines 3-3;

FIG. 4. is a schematic of a portion of the permanent magnet brushless motor in FIG. 3;

FIG. 5 is a graph of a cogging torque curve indicating cogging torque values associated with the permanent magnet brushless motor of FIG. 1;

FIG. 6 is a graph of a back electromotive force voltage curve associated with the permanent magnet brushless motor of FIG. 1;

FIG. 7 is a bar graph of a percentage of a fundamental frequency component associated with the permanent magnet brushless motor of FIG. 1;

FIG. 8 is a graph of an electromagnetic torque plot associated with the permanent magnet brushless motor of FIG. 1; and

FIG. 9 is a schematic of a permanent magnet brushless motor in accordance with another exemplary embodiment.

### DETAILED DESCRIPTION

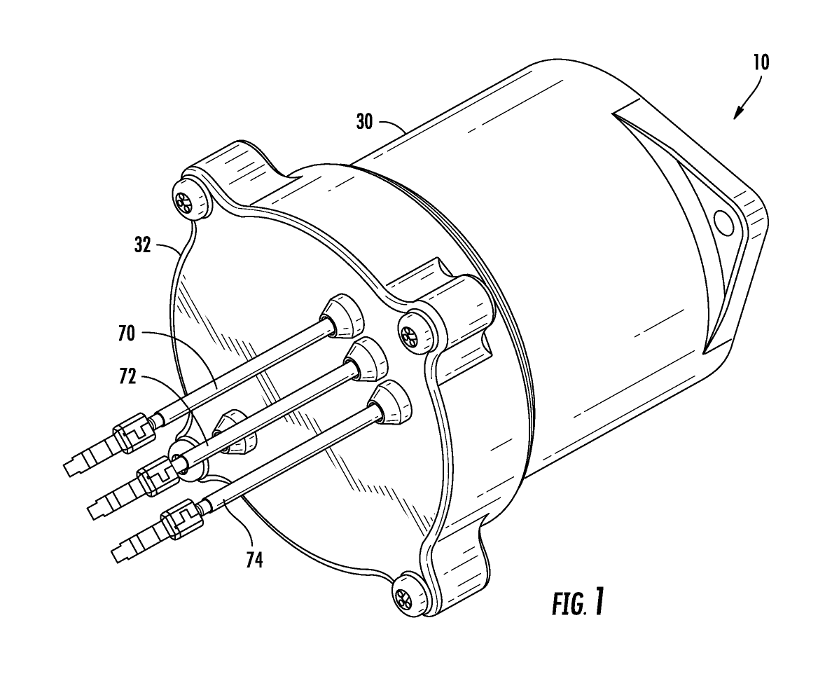

Referring to FIGS. 1-3 a permanent magnet brushless motor 10 in accordance with an exemplary embodiment is provided. The motor 10 includes a housing portion 30, a housing portion 32, a stator 50, a rotor 60, a shaft 65, and conductors 70, 72, 74.

The housing portions 30, 32 are configured to be coupled together and to hold the stator 50 and the rotor 60 therein. The conductors 70, 72, 74 extend through corresponding apertures in the housing portion 32. Also, the shaft 65 extends through an aperture extending through the housing portion 30.

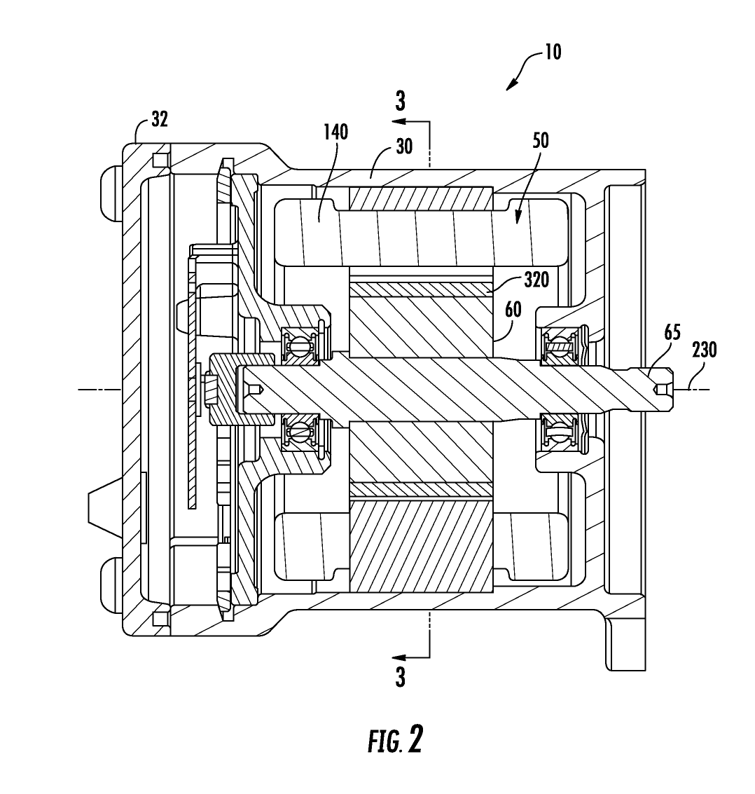

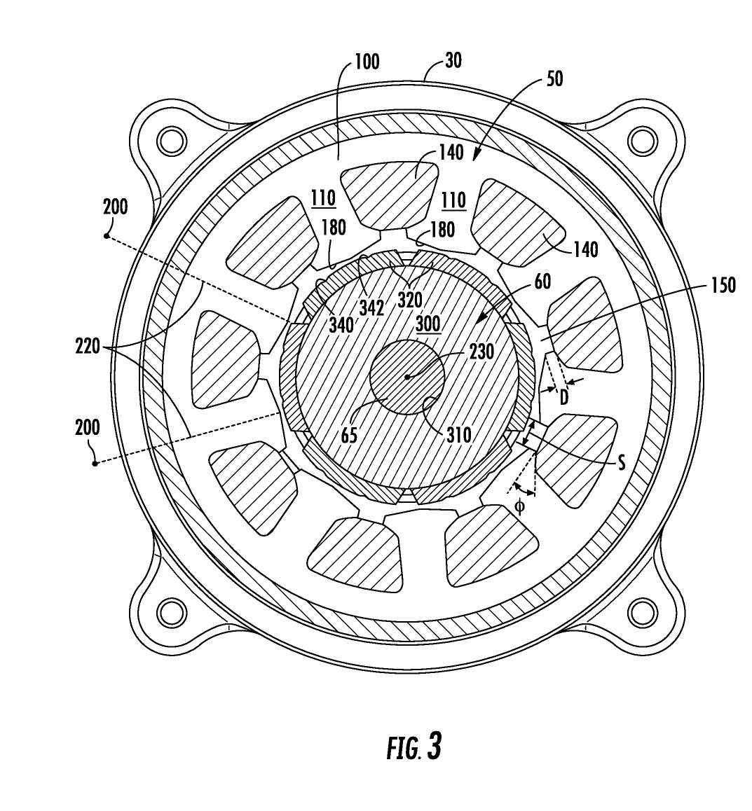

Referring to FIGS. 2 and 3, the stator 50 has a tubular-shaped member 100, a plurality of tooth members 110, a plurality of coil windings 140. The plurality of tooth members 110 extend radially inwardly from the tubular-shaped member 100. Each tooth member of the plurality of tooth members 100 has an arcuate-shaped convex surface 180 disposed proximate to an interior region 150 defined by the stator 50. Each arcuate-shaped convex surface 180 is defined by a respective first radius 220 that is rotated about a respective center point 200 that is disposed radially outside of the stator 50. Each arcuate-shaped convex surface 180 has an arcuate-shape to reduce the cogging torque in the motor 10. Also, it is noted that the center point 200 utilized to define each arcuate-shaped convex surface 180 is off-center from a central axis 230 of the rotor 60. Also, between each tooth member of the plurality of tooth members 100 is disposed a coil winding of the plurality of coil windings 140. The coil windings 140 are energized by operational voltages received via the conductors 70, 72 and 74.

It should be noted that other structural parameters of the stator 50 can be adjusted to reduce cogging torque of the motor 10. For example, referring to FIG. 3, the tooth member depth (D), the tooth member spacing (S) and the tooth member angle (Ø) can be adjusted to reduce cogging torque.

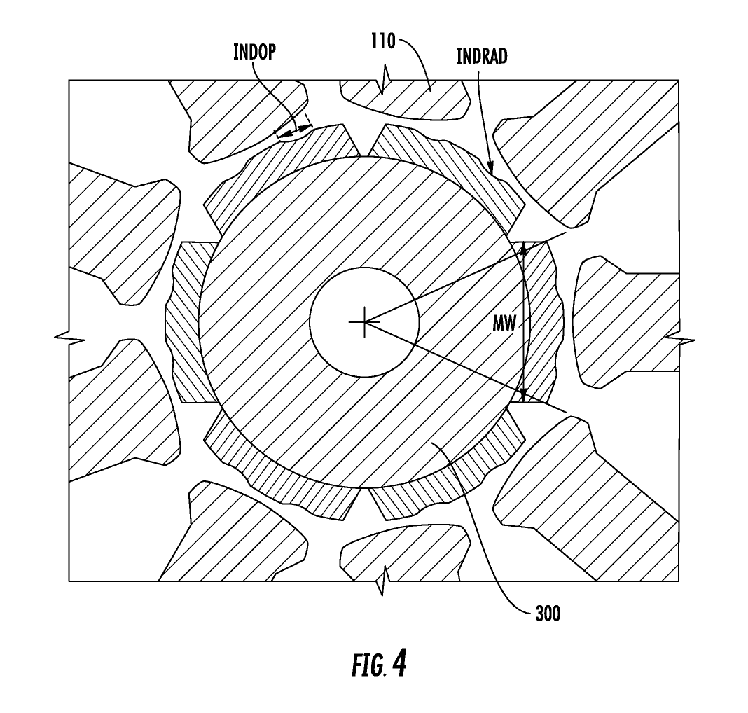

Referring to FIGS. 3 and 4, the rotor 60 is disposed within the interior region 150 of the stator 50. The rotor 60 rotates about the axis 230 in response to energization of the coil windings 140. The rotor 60 includes a cylindrical-shaped portion 300 with an aperture 310 extending axially therethrough. The rotor 60 further includes a plurality of permanent magnets 320 disposed on an outer surface of the cylindrical-shaped portion 300. Each magnet of the plurality of permanent magnets 320 has at least one notch disposed therein. The notch opening size (INDOP), the notch radius (INDRAD) and a number of notches can be adjusted to reduce a cogging torque of the motor 10. These notches can be formed utilizing a grinding process.

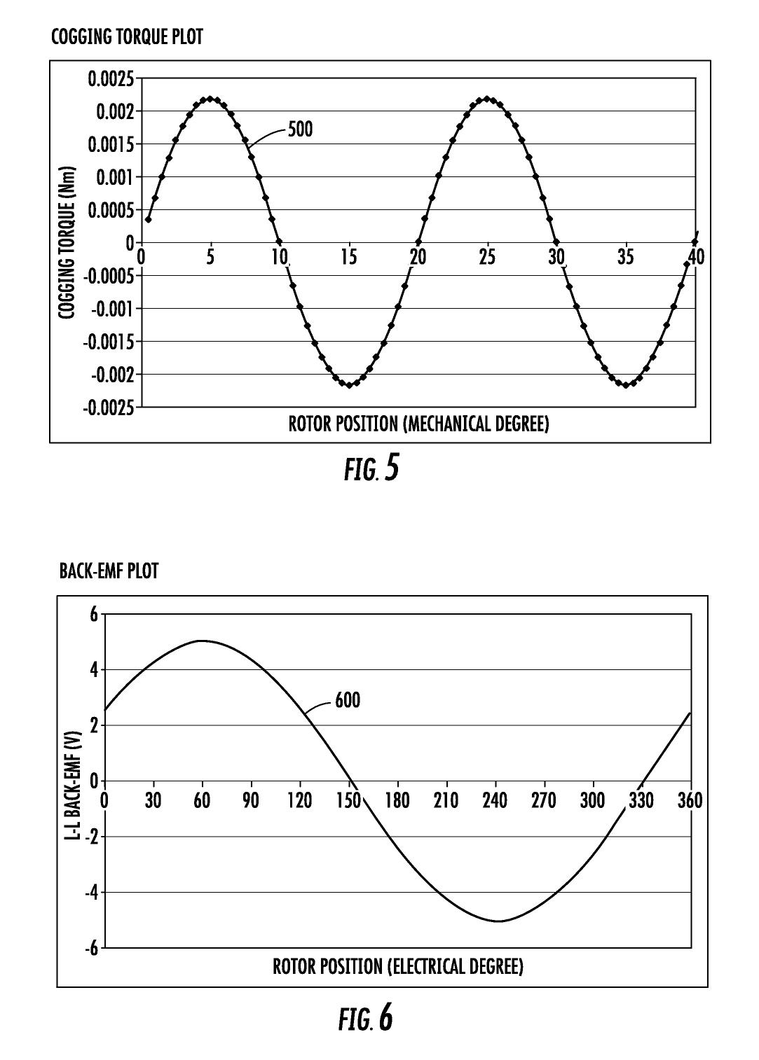

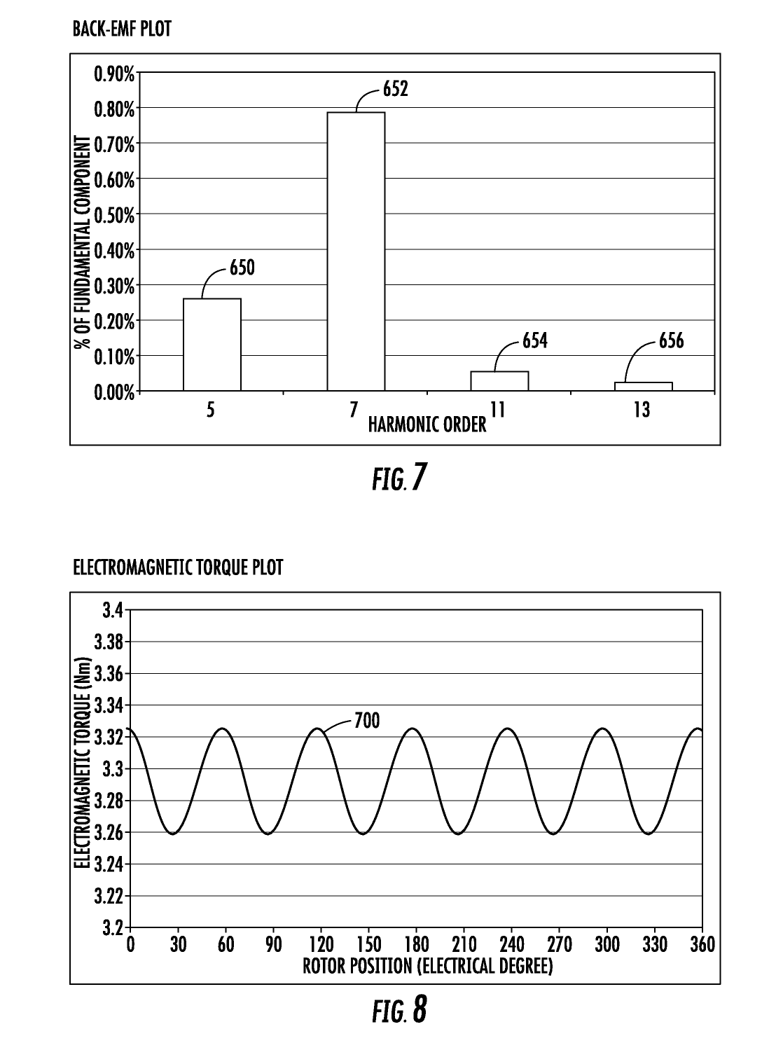

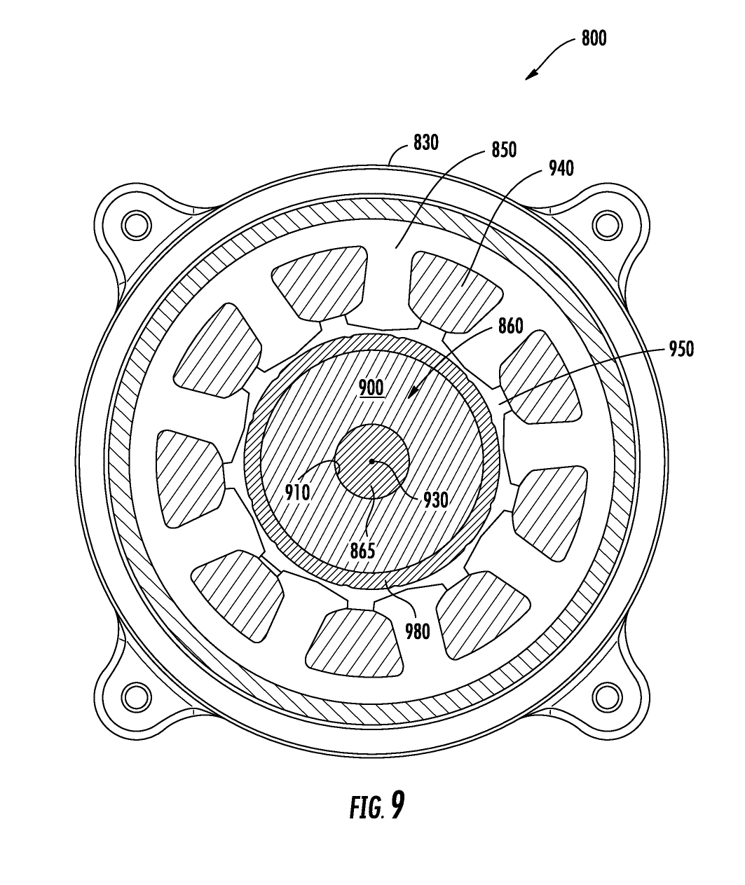

Referring to FIG. 5, a graph of a cogging torque curve 500 indicating cogging torque values associated with the motor 10 is illustrated. Also, referring to FIG. 6, a graph of a back electromotive force voltage curve 600 associated with the motor 10 is illustrated. Further, referring to FIG. 7, a bar graph of a percentage of a fundamental frequency components indicated by bars 650, 652, 654 and 656 that are associated with the motor 10 is illustrated. Still further, referring to FIG. 8, a graph of an electromagnetic torque curve 700 associated with the motor 10 is illustrated.

Referring to FIG. 9, a permanent magnet brushless motor 800 in accordance with another exemplary embodiment is provided. The motor 800 includes a housing portion 830, a stator 850, a rotor 860, and a shaft 865. The structure of the housing portion 830 is identical to the housing portion 30, and the structure of the stator 850 is identical to the stator 50. The primary structural difference between the motor 800 and the motor 10 is the structure of the rotor 860.

The rotor 860 is disposed within the interior region 950 of the stator 850. The rotor 860 rotates about the axis 930 in response to energization of the coil windings 940 of the stator 850. The rotor 860 includes a cylindrical-shaped portion 900 with an aperture 910 extending axially therethrough. The rotor 860 further includes a ring magnet 980 disposed on an outer surface of the cylindrical-shaped portion 900. The ring magnet 980 has at least one notch disposed therein. The notch opening size (INDOP), the notch radius (INDRAD) and a number of notches on the ring magnet 980 can be adjusted to reduce a cogging torque of the motor 800. These notches can be formed utilizing a grinding process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

Having thus described the invention, it is claimed:

1. A permanent magnet brushless motor, comprising:
a stator having a tubular-shaped member and a plurality of tooth members extending radially inwardly from the tubular-shaped member, each tooth member of the plurality of tooth members having an arcuate-shaped convex surface disposed proximate to an interior region defined by the stator, each arcuate-shaped convex surface being defined by a first radius that is rotated about a respective center point that is disposed radially outside of the stator; and
a rotor disposed within the interior region of the stator.

2. The permanent magnet brushless motor of claim 1, wherein the rotor has a cylindrical-shaped portion with an aperture extending axially therethrough, and a plurality of permanent magnets disposed on an outer surface of the cylindrical-shaped portion.

3. The permanent magnet brushless motor of claim 2, wherein each magnet of the plurality of permanent magnets has at least one notch disposed therein.

4. The permanent magnet brushless motor of claim 1, wherein the rotor has a cylindrical-shaped portion with an aperture extending axially therethrough, and a ring magnet disposed on an outer surface of the cylindrical-shaped portion.
